(19) United States
(12) Patent Application Publication
(10) Pub. No.: US 2002/0078076 A1
(43) Pub. Date: Jun. 20, 2002

(54) Simulator disposed between a server and a client system

(76) Inventor: David J. Evans, Ottawa (CA)

Correspondence Address: COBRIN & GITTES, 21 Floor, 750 Lexington Avenue, New York, NY, 10022, US

(21) Appl. No.: 09/738,721

(22) Filed: Dec. 15, 2000

(51) Int. Cl. G06F 12/00

(52) U.S. Cl. 707/204

(57) ABSTRACT

Information is transferred between a server system and a client system. Network data that includes a portion having state information is received from the server system. The portion is removed from the network data, and state information is appended to at least one address that corresponds to a link located in a remaining portion of the network data. The remaining portion of the network data is transmitted to the client system. Thereafter, a request is received from the client system and includes an address. A portion having state information is removed from the address, and the state information is formatted. A remaining portion of the address and the formatted state information are transmitted to the server system.

### BACKGROUND OF THE INVENTION

The present invention is directed to the transfer of information between a server system and a client system over a network and, more specifically, to the delivery of state information from a server system to a client system and its subsequent delivery from the client system to the server system.

To access a World Wide Web (“Web”) document over the Internet, a user typically enters a Uniform Resource Locator (URL) for the Web document into a location on a Web browser program display screen or, alternatively, clicks on a hyperlink to the Web document that is displayed on a Web page. The Web browser, using the URL, then sends a Hypertext Protocol (HTTP) request that is directed to the server where the Web document is stored. The Web server responds to the HTTP request by sending an HTTP object, such as a plain text document written in Hypertext Markup Language (HTML), to the client.

When the server responds to the HTTP request, the server may also send a piece of state information, known as a “cookie”, that is to be stored by the client system. Included in the cookie is a description of a range of URLs to which the state information is to be returned. When the client system subsequently sends a HTTP request to a server whose URL is within the range of URLs contained in the cookie, the client also transmits the current value of the state information.

The ability to transfer state information back and forth enables the server to play a more active role in transactions between the clients and the servers and expands the types of applications that can be used in a Web-based environment. As an example, an on-line shopping application may use cookies to store information about items currently selected by a consumer. Further, an on-line service can send user registration information back to the client system in a cookie so that a user need not re-enter the user information each time the user is reconnected to the service. Also, a Web site can store user preferences on the client system in one or more cookies so that the client system can supply it with the user preferences when the site is later accessed.

However, not all Web browser programs support cookies. Further, some users disable their browser program's capability of storing cookies because of privacy concerns or other concerns. The state information is not retained in the client system, thereby limiting the capabilities of the Web-based applications.

Also, Web sites or other Internet applications that are created using the Active Server Pages (ASP) programming environment require cookies to operate properly. When a Web site or application is first accessed, the ASP environment creates a session identifier (ID) that is sent as a cookie to be stored in the client system. When the client system sends subsequent requests for Web page to the ASP environment, the client sends the cookie containing the session ID back to the ASP environment so that the ASP environment can determine the session associated with the client and retrieve and manage data associated with the session. For example, the ASP environment may retrieve user preferences associated with the session to determine the Web page to be returned to the client.

When the client system Web browser does not support cookies or when the Web browser has been configured not to accept cookies, the ASP environment does not receive the session ID when a Web page is requested by a client system and cannot determine which session is associated with the client. Therefore, the ASP environment cannot retrieve data associated with the session and cannot properly manage the session.

It is therefore desirable to retain cookies and/or other state information that is intended to be stored in the client system and return the cookies or other state information to the server with subsequent Web page requests.

### SUMMARY OF THE INVENTION

The present invention simulates the storage of a cookie or other state information in a client system and simulates the transmission of the cookie or other state information from the client system to the server such that it appears to the server that the cookie or other state information was transmitted by the client system.

In accordance with an aspect of the invention, information is transferred from a server system to a client system. Network data that includes a portion having state information is received from the server system. The portion is removed from the network data, and state information is appended to at least one address that corresponds to a link located in a remaining portion of the network data. The remaining portion of the network data is transmitted to the client system.

According to another aspect of the invention, information is transferred from a client system to a server system. A request is received from the client system and includes an address. A portion having state information is removed from the address, and the state information is formatted. A remaining portion of the address and the formatted state information are transmitted to the server system.

In accordance with the aspects of the invention, a content switch may receive a data stream that includes the network data or the request.

In accordance with a further aspect of the invention, a computer readable medium includes instructions for the operations.

Other features and advantages of the present invention will become apparent from the following detailed description of the invention with reference to the accompanying drawings.

### BRIEF DESCRIPTION OF THE DRAWINGS

The invention will now be described in greater detail in the following detailed description with reference to the drawings in which:

FIG. 1 is a block diagram showing an arrangement for simulating a client system receiving and storing cookies transmitted by a server and for simulating a client system retransmitting cookies to a server in accordance with the invention.

FIG. 2 is a block diagram showing another arrangement for simulating a client system receiving and storing cookies transmitted by a server and for simulating a client system retransmitting cookies to a server in accordance with the invention.

FIG. 3 is a block diagram showing a further arrangement for simulating a client system that receives and stores cookies transmitted by a server and that simulates a client system retransmitting cookies to a server in accordance with the invention.

FIG. 4 is a block diagram showing a still further arrangement that simulates a client system receiving and storing cookies transmitted by server and that simulates a client system retransmitting cookies to a server in accordance with the invention.

FIG. 5 is a flow chart illustrating a sequence of operations for simulating a client system receiving and storing cookies transmitted by a server in accordance with the invention.

FIG. 6 is a flow chart illustrating a sequence of operations for simulating a client system retransmitting cookies to server in accordance with the invention.

### DETAILED DESCRIPTION OF THE INVENTION

The invention simulates a client system receiving and storing cookies or other state information that are transmitted by a server and simulates the client system retransmitting the cookies to the server. When a Web browser program, or similar program, of the client system is unable to accept cookies or other state information or is configured not to accept cookies or other state information, the client can nevertheless receive Web pages or other network data from network sites that require the storage of cookies or other state information in the client system. The simulated receiving, storage and retransmission of the cookies is carried out in a manner that permits the caching of Web pages or other network data and which does not further burden the server.

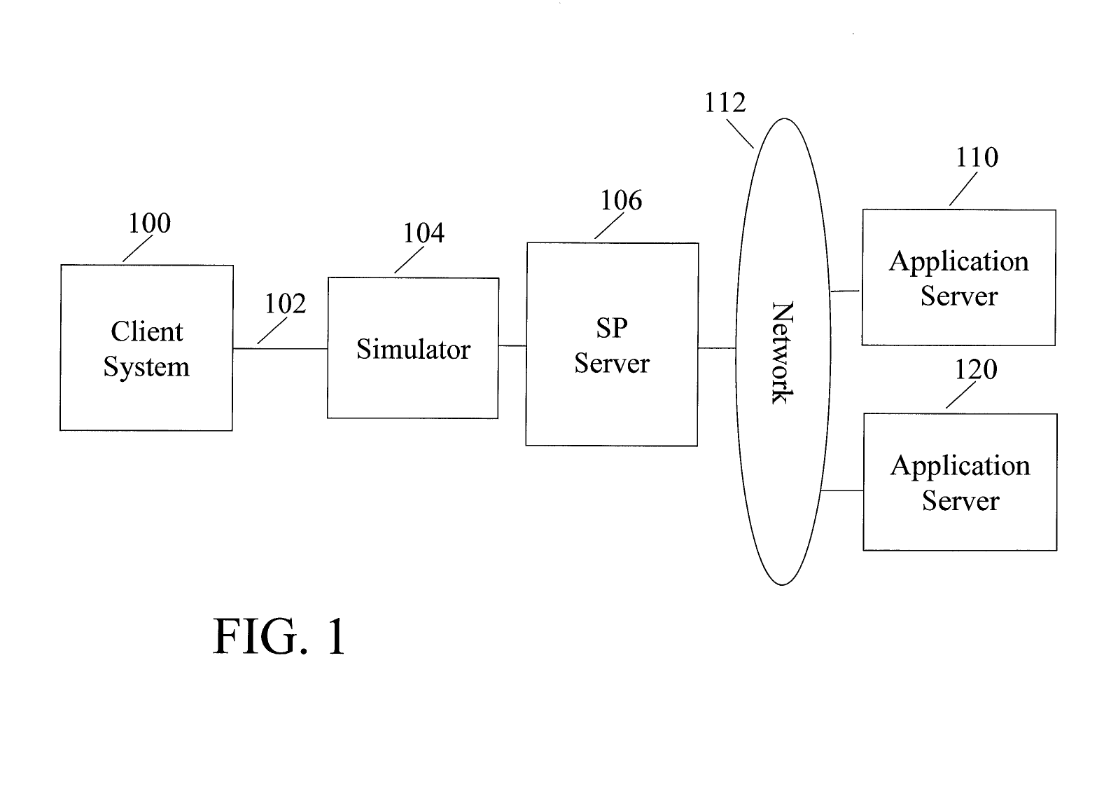

FIG. 1 shows an example of the invention. A client system 100 is connected to an application or host server 110 via a service provider (SP) server 106, also known as a proxy server, and via a network 112 for accessing network-based services retained at the application or host server.

The client 100 may be a personal device, such as a personal computer (PC), a personal digital assistant (PDA), or other handheld or pocket device, or may be a public device, such as a kiosk. The client 100 is connected to the SP server 106 via a connection 102 such as a plain old telephone service (POTS) line, a digital subscriber line (DSL), an asymmetric digital subscriber line (ADSL), an Integrated Service Digital Network (ISDN) line, a T1 line, a T3 line, a digital wireless or analog wireless transmission path, and/or a cable modem and cable network, etc.

The service provider (SP) server 106 may be an Internet service provider (ISP) server, a message service provider (MSP) server or other network-based service provider server. The SP server 106 provides connections between the device 100 and one or more host servers 110, 120 such as application servers, email servers, or other messaging servers, or Web servers, which provide one or more network-based services. The connection is provided via a network 112, such as an Internet provider (IP) network, the Internet, an Intranet or other network.

The client system 100 accesses network data, such as Web pages, stored in the server 110. A browser program or similar program of the client system sends a request for the network data, such as a HTTP request using the URL of a Web page, to the SP server 106. The SP server transmits the request to the application server 110 via the network 112. The server 110 responds to the request by sending the document, such as an HTTP object that includes a plain text document written in Hypertext Markup Language (HTML), to the SP server 106 via the network 112. The SP server then delivers the document to the client system 100.

When the server 110 responds to the request, the server may also send a piece of state information, such as in the format of a “cookie” or in another format, to be stored by the client system 100. When the client system sends a subsequent request, such as a request for a Web page, other network document, streaming data, or other network data, to the server 110 or to another server 120 whose address, such as a URL, is within the range of addresses contained in the cookie or the like, the client 100 also sends the cookie or the like to the server together with the request.

When the Web browser or similar program of the client system 100 does not support cookies or is configured not to accept cookies, the client system does not store the received cookie and cannot subsequently send the cookie to the server 110 or 120. Thus, the server may be unable to run an application using all of its capabilities and, in fact, my be unable to run the application at all. Further, when the server 110 or 120 operates in an environment, such as the ASP environment, in which a session ID or other identifier is to be sent to and received from the client system and when the server does not receive the session ID or other identifier, the server cannot determine which session is associated with the client, cannot retrieve data that is associated with the session and therefore cannot properly manage the session.

The invention thus provides a simulator 104, such as a cookie simulator, which may be disposed between the SP server 106 and the client system 100. The simulator 106 receives, from the application server 110 via the network 112 and via the SP server 106, network data having a portion, such as a HTTP header, that includes a request to store a cookie or other state information. The simulator removes the portion containing the cookie or other state information and modifies any address links that are contained in the network data, such as hyperlinks to URLs contained in a Web page, by appending the information to the links. The simulator then transmits the remaining portion of the network data to the client system so that the state information is retained when the browser program or similar program in the client system 100 does not store cookies.

Then, when the browser program or similar program in the client system 100 sends a request for an address such as by the user clicking on a link contained in the network data, the simulator 104 looks for any state information appended to the address, reconstructs the state information in the form of a cookie or in another format, and transmits the request together with the cookie or other formatted state information to the SP server 106.

Alternatively, the simulator 104 is disposed between the network 112 and the SP server 106. The simulator receives network data from the network 112, removes the portion containing the cookie or other state information, carries out the above-described operations, and transmits a remaining portion of the network data, which is modified as described above, to the SP server 106. The simulator also receives requests for addresses via the SP server 106, performs the operations described above and transmits the request and the cookie or other formatted state information to the network 112.

As a further alternative, the simulator 104 is integral with the SP server 106 and carries out the above-described operations within the SP server.

The cookie simulator may be comprised of instructions for carrying out these operations that are stored in a computer readable medium such as a hard drive, CD-ROM, disk or diskette, memory chip, etc.

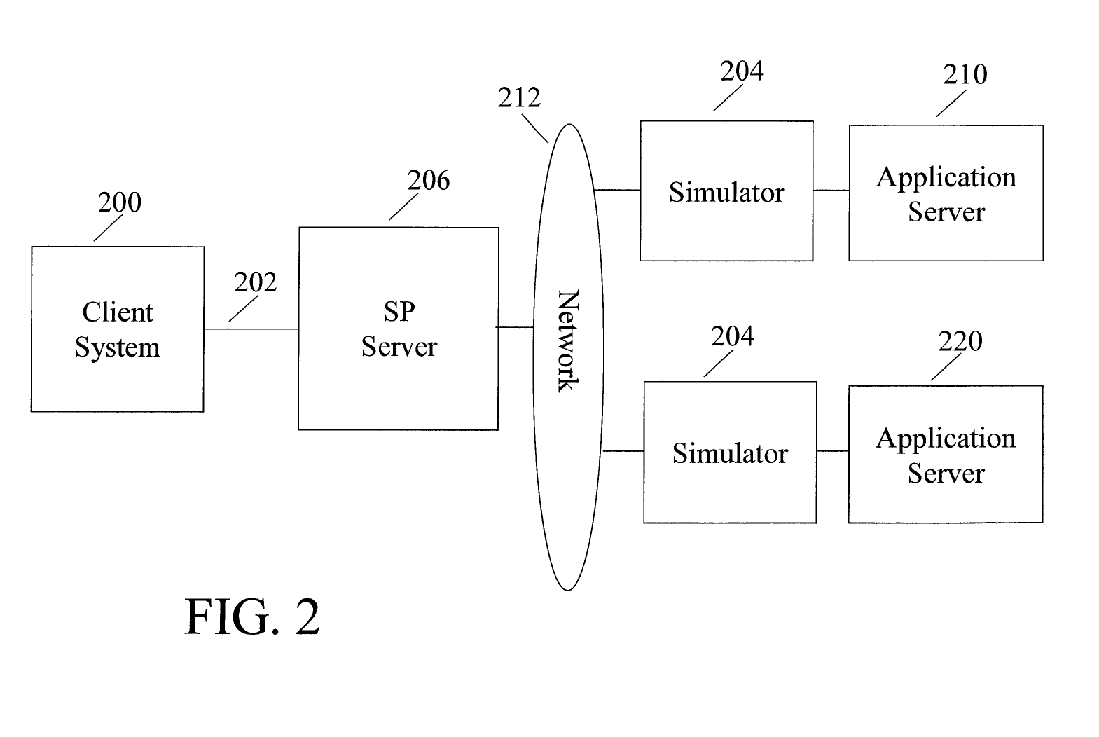

FIG. 2 shows an alternate arrangement of the invention wherein one or more simulators 204 are disposed between the network 212 and one or more application or host servers 210. The simulator 204 receives network data from one of the application or host servers 210, and carries out the operations described above. The simulator 204 the transmits a modified remaining portion of the network data, via a network 212 and a SP server 206, to a client system 200.

When the client system 200 sends a request for an address contained in the network data, such as a request for a URL, the request is delivered via the SP server 206 and the network 212 to the simulator 204. The simulator 204 performs the above-described operations and transmits the request and a cookie or other formatted state information to the application server 210.

The simulator may be integrated within a content switch, also known as a URL switch, an Open Standard Interconnection (OSI) reference model layer 7 switch or web switch, which is capable of switching data at the application layer instead of at the lower OSI layers (4-1). The content switch inspects data in a stream fabric and redirects or modifies the data so that the content switch can identify or modify, for example, HTTP request headers, cookies and URLs.

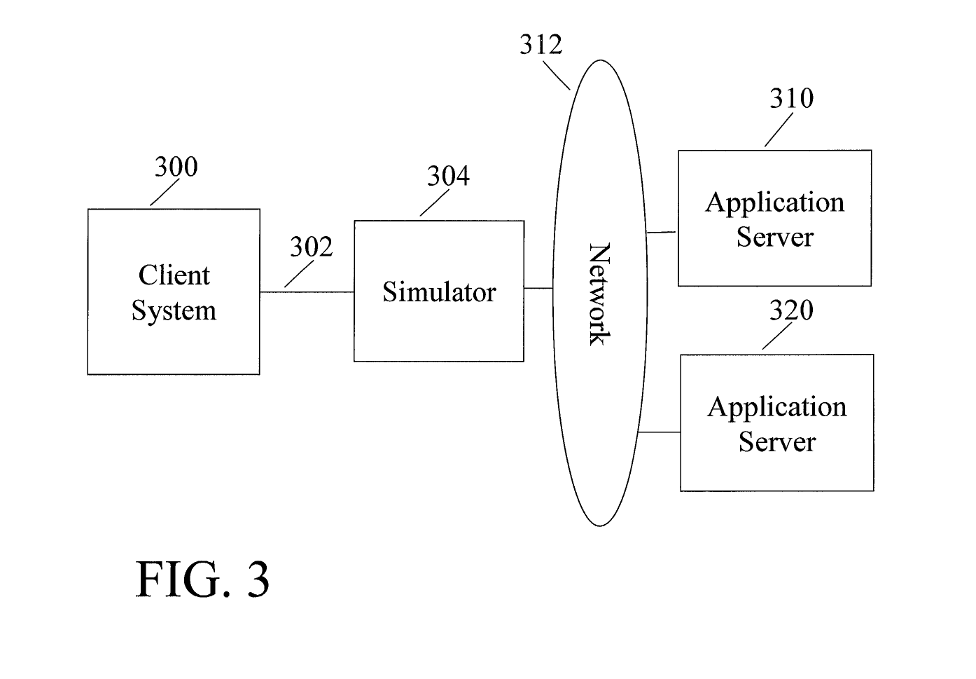

FIG. 3 shows another arrangement of the invention that is similar to the arrangement shown in FIG. 1 except that the client system 300 and the simulator 304 are connected directly to the network 312 and access network-based services retained at the application server 310 or 320.

The simulator 304 receives network data from one of the application servers 310, 320 directly via the network 312, performs the operations described above, and then transmits a modified remaining portion of the network data via the network 312 to the client system 300.

When the client system subsequently sends a request for an address contained in the network data, the simulator 304 carries out the operations described above and then transmits the request and a cookie or other formatted state information via the network 312 to the application server 310 or 320.

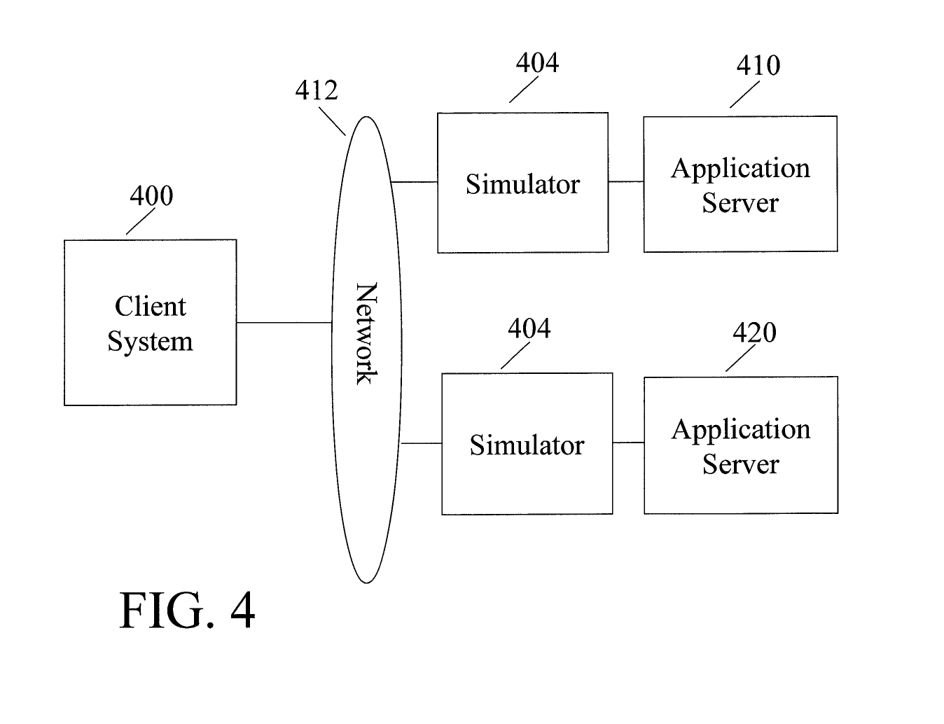

FIG. 4 shows a further alternative arrangement of the invention that is similar to the arrangement shown in FIG. 2 except that the client system 400 is directly connected to the network 412. A simulator 404, which is disposed between the network 412 and at least one application server 410, receives network data from the application server 410. The simulator carries out the above-described operations and transmits a modified remaining portion of the network data via the network 412 to the client system 400.

When a request for an address contained in the network data is transmitted by the client system 400 and delivered via the network 412 to the simulator 404, the simulator 404 performs the operations described above. The simulator then transmits the request and a cookie or other formatted state information to the application server 410.

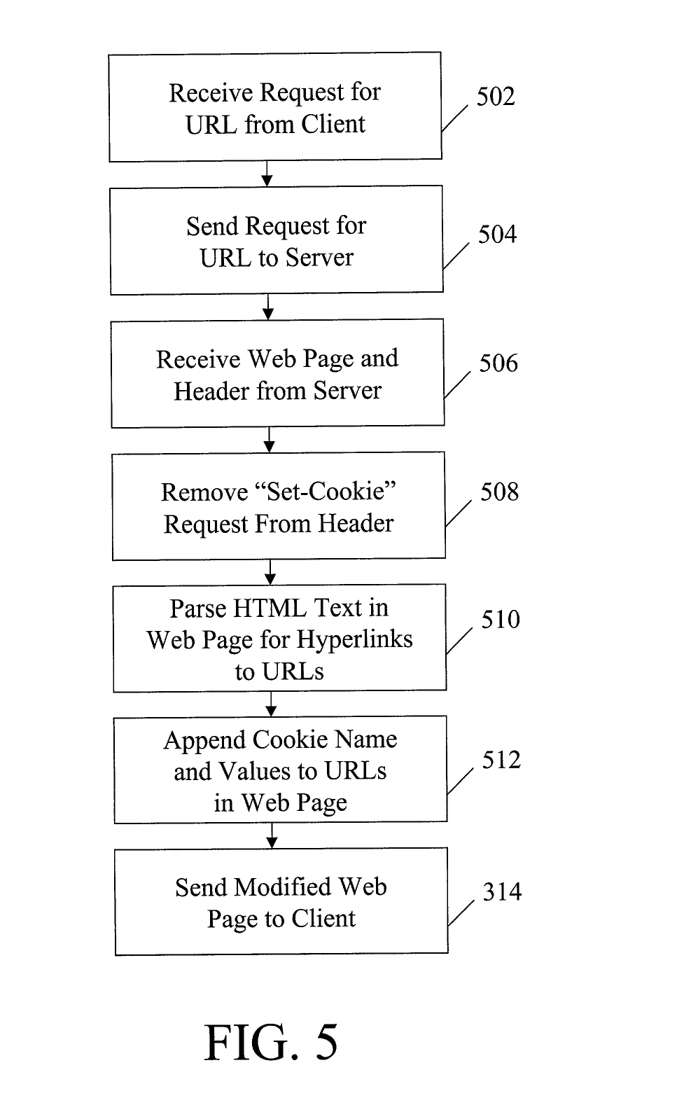

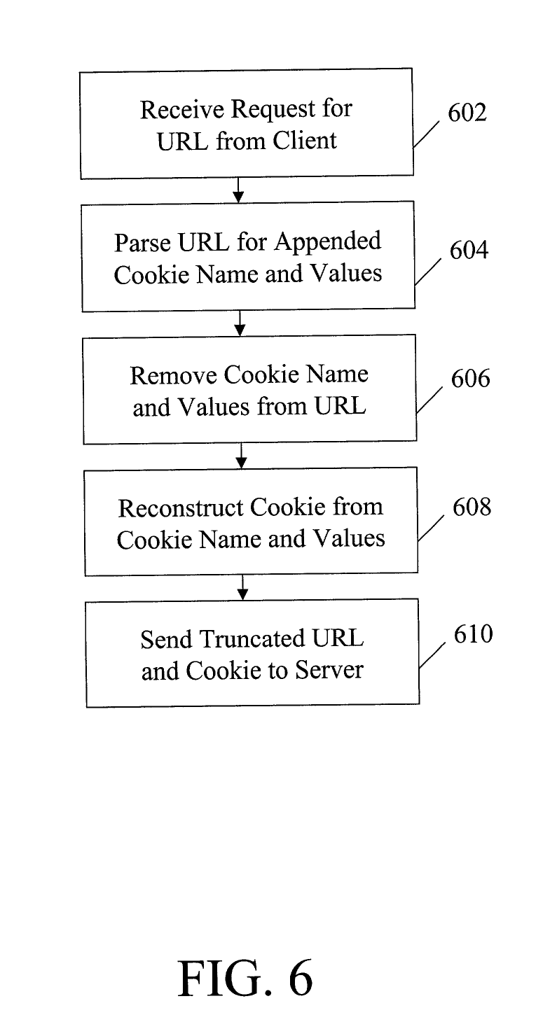

FIGS. 5 and 6 are flow charts that illustrate an example of the operation of the simulator of the invention.

As FIG. 5 shows, the simulator receives a request for a URL or other address from a client system, as step 502 shows, and transmits the request for delivery to the application server, as shown at step 504. The application server transmits a HTTP object, or other network data, that includes the data or web page at the requested URL or other address as well as a header or other added portion that are received by the simulator, as step 506 shows.

One or more cookies or other formatted state information are included in a HTTP header, or in another added portion of the document, of the network data. The header may have the format:

Set-Cookie: NAME=VALUE; expires=DATE; path=PATH;

domain=DOMAIN_NAME; secure

where “NAME” is a name for the cookie, “VALUE” is a string of characters assigned to the name, “expires” specifies the lifetime of the cookie, “domain=DOMAIN_NAME” defines the domain for which the cookie is valid, namely the domains of the servers to which the cookie is later returned, “path” is a subset of file system directories in a domain for which the cookie is valid, and “secure” indicates that the cookie may only be retransmitted if there is a secure communication channel to the server. The “NAME” attribute is the only required attribute in the “Set-Cookie” header.

Ordinarily, when a client system browser program is configured to receive a “Set-Cookie” command within a HTTP header, the client stores the cookie. If the cookie matches the “NAME”, “domain” and “path” attributes of a previously received cookie, then the previously received cookie is overwritten. Then, when the client system sends a HTTP request, the client system first examines its cookie list to see if the cookie list contains any matching cookies that are to be sent with the request. Specifically, the client compares the URL of the requested Web document against all of its stored cookies, and if any of the cookies in the cookie list matches the requested URL, then information containing the NAME=VALUE of the matching cookies is sent along with the HTTP request. When the browser program of the client system is unable to store cookies or is configured not to accept cookies, the information containing the NAME=VALUE of the cookies cannot be sent along with the HTTP request.

When the simulator of the invention receives the HTTP object or other network data and the browser program or similar program of the client's system is unable to accept cookies or is configured not to accept cookies, the simulator nevertheless permits the state information to be stored and then returned with any subsequent network data requests. As step 508 shows, the simulator removes the portion of the network data that contains the state information, such as the “Set-Cookie” request from the HTTP header. Then, as shown at step 510, the simulator parses the text in the remaining portion of the network data, such as HTML text in a Web page, for links to other addresses, such as hyperlinks to other URLs. The simulator appends the cookie name and values or other state information to the URLs or other addresses that are contained in the links in the Web page or other network data, as step 512 shows. The simulator thereafter sends the modified Web page or modified other remaining portion of the network data to the client system, as shown at step 514.

FIG. 6 illustrates the operation of the simulator when a request for a Web page or other network data is subsequently received from the client system. A HTTP request for a URL, or other request for network data, is received from the client system, as step 602 shows. The simulator parses the URL or other address located in the request to find an appended cookie name and its value or other state information, as shown at step 604. When such information is found, the cookie name and value or other state information is deleted from the end of the URL or other address, as shown at step 606. The simulator then reconstructs a cookie from the cookie name and value, or reconstructs the state information in another format, as step 608 shows. The simulator then sends a request for a Web page or other network data that contains the truncated URL or other address, together with the cookie or other formatted information, to the application server, as shown at step 610. The application server receives the request and the cookie or other formatted information in the same format as if the request and the cookie or other formatted information were transmitted by the client system.

Thus, the simulator of the invention permits a client system whose browser program or similar program does not permit cookies, or which has been configured not to accept cookies, to access Web sites or other network locations that require cookies or other state information. The simulator also permits the Web sites or other network locations to run applications at their intended capabilities as well as to properly manage ASP sessions.

The cookie simulation is carried out at a location between the application or host server and the client system and therefore does not further burden the application server. Further, a Web cache or other cache that is located between the simulator and the host or application server receives Web pages or other network data in which the URLs or other addresses therein have not been changed and does not receive Web pages or other network data in which URLs or other addresses have been modified to include cookie or other state information. Thus, the cache is able to cache the Web pages or other network data that are suitable for later access by the client system or by other client systems, so that repeated requests to the application server for the same Web pages or other network data are reduced. Moreover, the simulator may be integrated within a device having the capability of caching Web pages or other network data.

Although the present invention has been described in relation to particular embodiments thereof, many other variations and modifications and other uses may become apparent to those skilled in the art. It is preferred, therefore, that the present invention be limited not by this specific disclosure herein, but only by the appended claims.

What is claimed is:

1. A method of transferring information from a server system to a client system, said method comprising:
receiving, from said server system, network data that includes a portion having state information;
removing said portion from said network data;
appending said state information to at least one address corresponding to a link located in a remaining portion of said network data; and
transmitting said remaining portion of said network data to said client system.

2. The method of claim 1 further comprising the step of parsing said remaining portion of said network data for said at least one address prior to said appending step.

3. The method of claim 1 wherein said receiving step includes receiving a data stream that includes said network data.

4. The method of claim 1 wherein said network data comprises a Web document.

5. The method of claim 1 wherein said portion of said network data comprises a Hypertext Protocol (HTTP) header that includes a request to store a cookie.

6. The method of claim 1 wherein said state information comprises a cookie name and a value.

7. The method of claim 1 wherein said link comprises a hyperlink to a Web page and said at least one address comprises a Uniform Resource Locator (URL) of said Web page.

8. The method of claim 1 wherein said remaining portion of said network data comprises a Web page.

9. A method of transferring information from a client system to a server system, said method comprising:
receiving, from said client system, a request including an address;
removing a portion from said address having state information;
formatting said state information; and
transmitting a remaining portion of said address and said formatted state information to said server system.

10. The method of claim 9 further comprising the step of parsing said address for said state information prior to said removing step.

11. The method of claim 9 wherein said receiving step includes receiving a data stream that includes said request.

12. The method of claim 9 wherein said request comprises a Hypertext Protocol (HTTP) request.

13. The method of claim 9 wherein said request comprises a request for a Web document.

14. The method of claim 9 wherein said state information includes a cookie name and a value.

15. The method of claim 9 wherein said remaining portion of said address includes a Uniform Resource Locator (URL) of a Web page.

16. The method of claim 9 wherein said formatted state information comprises a cookie.

17. An apparatus for transferring information from a server system to a client system, said apparatus being configured to:
receive, from said server system, network data that includes a portion having state information;
remove said portion from said network data;
append said state information to at least one address corresponding to a link located in a remaining portion of said network data; and
transmit said remaining portion of said network data to said client system.

18. The apparatus of claim 17 further configured to parse said remaining portion of said network data for said at least one address prior to appending said state information.

19. The apparatus of claim 17 wherein said apparatus is a content switch and is further configured to receive a data stream that includes said network data.

20. The apparatus of claim 17 wherein said network data comprises a Web document.

21. The apparatus of claim 17 wherein said portion of said network data comprises a Hypertext Protocol (HTTP) header that includes a request to store a cookie.

22. The apparatus of claim 17 wherein said state information comprises a cookie name and a value.

23. The apparatus of claim 17 wherein said link comprises a hyperlink to a Web page and said at least one address comprises a Uniform Resource Locator (URL) of said Web page.

24. The apparatus of claim 17 wherein said remaining portion of said network data comprises a Web page.

25. An apparatus for transferring information from a client system to a server system, said apparatus being configured to:
receive, from said client system, a request including an address;
remove a portion from said network address having state information;
format said state information; and
transmit a remaining portion of said address and said formatted state information to said server system.

26. The apparatus of claim 25 further configured to parse said address for said state information prior to removing said portion from said address.

27. The apparatus of claim 25 wherein said apparatus is a content switch and is further configured to receive a data stream that includes said request.

28. The apparatus of claim 25 wherein said request comprises a Hypertext Protocol (HTTP) request.

29. The apparatus of claim 25 wherein said request comprises a request for a Web document.

30. The apparatus of claim 25 wherein said state information includes a cookie name and a value.

31. The apparatus of claim 25 wherein said remaining portion of said address includes a Uniform Resource Locator (URL) of a Web page.

32. The apparatus of claim 25 wherein said formatted state information comprises a cookie.

33. An apparatus for transferring information from a server system to a client system, said apparatus comprising:
means for receiving, from said server system, network data that includes a portion having state information;
means for removing said portion from said network data;
means for appending said state information to at least one address corresponding to a link located in a remaining portion of said network data; and
means for transmitting said remaining portion of said network data to said client system.

34. An apparatus for transferring information from a client system to a server system, said apparatus comprising:
means for receiving, from said client system, a request including an address;
means for removing a portion from said address having state information;
means for formatting said state information; and
means for transmitting a remaining portion of said address and said formatted state information to said server system.

35. A computer readable medium, comprising:
instructions for transferring information from a server system to a client system, said instructions comprising:
instructions for receiving, from said server system, network data that includes a portion having state information;
instructions for removing said portion from said network data;
instructions for appending said state information to at least one address corresponding to a link located in a remaining portion of said network data; and
instructions for transmitting said remaining portion of said network data to said client system.

36. The medium of claim 35 further comprising instructions for parsing said remaining portion of said network data for said at least one address prior to appending said state information.

37. The medium of claim 35 wherein said instructions for receiving includes instructions for receiving a data stream that includes said network data.

38. The medium of claim 35 wherein said network data comprises a Web document.

39. The medium of claim 35 wherein said portion of said network data comprises a Hypertext Protocol (HTTP) header that includes a request to store a cookie.

40. The medium of claim 35 wherein said state information comprises a cookie name and a value.

41. The medium of claim 35 wherein said link comprises a hyperlink to a Web page and said at least one address comprises a Uniform Resource Locator (URL) of said Web page.

42. The medium of claim 35 wherein said remaining portion of said network data comprises a Web page.

43. A computer readable medium comprising:
instructions for transferring information from a client system to a server system, said instructions comprising:
instructions for receiving, from said client system, a request including an address;
instructions for removing a portion from said address having state information;
instructions for formatting said state information; and
instructions for transmitting a remaining portion of said address and said formatted state information to said server system.

44. The medium of claim 43 further comprising instructions for parsing said address for said state information prior to removing said portion.

45. The medium of claim 43 wherein said receiving step includes receiving a data stream that includes said request.

46. The medium of claim 43 wherein said request comprises a Hypertext Protocol (HTTP) request.

47. The medium of claim 43 wherein said request comprises a request for a Web document.

48. The medium of claim 43 wherein said state information includes a cookie name and a value.

49. The medium of claim 43 wherein said remaining portion of said address includes a Uniform Resource Locator (URL) of a Web page.

50. The medium of claim 43 wherein said formatted state information comprises a cookie.

51. A method of transferring information from a host server system to a client system, said method comprising:
receiving, from said host server system, a Web document that includes a Hypertext Protocol (HTTP) header that includes a request to store a cookie;
parsing said HTTP header of said Web document to locate said cookie;
removing said cookie from said Web document;
appending said cookie to at least one Uniform Resource Locator (URL) within a hyperlink to a Web page located within a further Web page of said Web document; and
transmitting said Web document to said client system.

52. A method of transferring information from a client system to a host server system, said method comprising:
receiving, from said client system, a request for a Web page document, said request including a Uniform Resource Locator (URL);
parsing said URL for cookie information;
removing said cookie information from said URL;
formatting a cookie from said cookie information; and
transmitting a remaining portion of said URL and said cookie to said host server system.

53. An apparatus for transferring information from a host server system to a client system, said apparatus being configured to:
receive, from said post server system, a Web documetn that includes a Hypertext Protocol (HTTP) header that includes a request to store a cookie;
parse said HTTP header of said Web document to locate said cookie;
remove said cookie from said Web document;
append said cookie to at least one Uniform Resource Locator (URL) within a hyperlink to a Web page located within a further Web page of said Web document; and
transmit said Web document to said client system.

54. An apparatus for transferring infornation from a client system to a host server system, said apparatus being configured to:
receive, from said client system, a request for a Web page document, said request including a Uniform Resource Locator (URL);
parse said URL for cookie information;
remove said cookie information from said URL;
format a cookie from said cookie information; and
transmit a remaining portion of said URL and said cookie to said host server system.

55. A computer readable medium comprising:
instructions for transferring information from a host server system to a client system, comprising:
instructions for receiving, from said host server system, a Web document that includes a Hypertext Protocol (HTTP) header that includes a request to store a cookie;
instructions for parsing said HTTP header of said Web document;
instructions for removing said cookie from said Web document;
instructions for appending said cookie to at least one Uniform Resource Locator (URL) within a hyperlink to a Web page located within a further Web page of said Web document; and
instructions for transmitting said Web document to said client system.

56. A computer readable medium comprising:
instructions for transferring information from a client system to a host server system, comprising:
instructions for receiving, from said client system, a request for a Web page document, said request including a Uniform Resource Locator (URL);
instructions for parsing said URL for cookie information;
instructions for removing said cookie information from said URL;
instructions for formatting a cookie from said cookie information; and
instructions for transmitting a remaining portion of said URL and said cookie to said host server system.
